(19) United States
(12) Patent Application Publication
(10) Pub. No.: US 2007/0239256 A1
(43) Pub. Date: Oct. 11, 2007

(54) Medical devices having electrical circuits with multilayer regions

(76) Inventors: Jan Weber, Maple Grove, MN (US); Karl Jagger, Deephaven, MN (US)

Correspondence Address: FISH & RICHARDSON PC, P.O. BOX 1022, MINNEAPOLIS, MN, 55440-1022, US

(21) Appl. No.: 11/387,033

(22) Filed: Mar. 22, 2006

(51) Int. Cl. G03B 21/60

(52) U.S. Cl. 623/1.15; 359/452

(57) ABSTRACT

The present invention relates to implantable or insertable medical devices that contain a substrate and one or more electrical circuits disposed over the substrate. The electrical circuits in the devices of the present invention contain at least one multilayer region, which in turn contains (a) a plurality of polyelectroyte layers which contain at least one type of polyelectrolyte and/or (b) a plurality of particle layers which contain at least one type of charged particle.

### STATEMENT OF RELATED APPLICATION

This application is related to U.S. Ser. No. ______, entitled “Medical Devices” filed on even date herewith [Attorney Docket No. 10527-661001/05-00148 (02)], which is a continuation-in-part of, and claims priority under 35 U.S.C. § 120, to U.S. patent application Ser. No. 11/198,961, filed on Aug. 8, 2005. Each of these applications is hereby incorporated by reference in its entirety.

### FIELD OF THE INVENTION

The present invention relates to medical devices and more particularly with medical devices that contain one or more electrical circuits.

### BACKGROUND OF THE INVENTION

Electronic circuitry plays an ever-widening role in medical devices including implantable and insertable devices. Although discrete components, such as conductive, resistive, capacitive and inductive surface-mount components, may be employed in such devices, it is frequently desirable to more closely integrate such components into the structure of the medical device.

### SUMMARY OF THE INVENTION

The present invention relates to implantable or insertable medical devices that contain a substrate and one or more electrical circuits disposed over the substrate. The electrical circuits in the devices of the present invention contain at least one multilayer region, which in turn contains (a) a plurality of polyelectroyte layers which contain at least one type of polyelectrolyte, (b) a plurality of particle layers which contain at least one type of charged particle, or (c) both a plurality of polyelectroyte layers which contain at least one type of polyelectrolyte and a plurality of particle layers which contain at least one type of charged particle.

An advantage of the present invention is that medical devices may be provided in which various components, including conductive, resistive, capacitive and inductive components, are closely integrated into the device structure.

Another advantage of the present invention is that medical devices may be supplied, which contain components, including conductive, resistive, capacitive and inductive components, that are ultrathin, flexible and/or capable of conforming and adhering well to complex underlying three-dimensional substrates.

These and other aspects, embodiments and advantages of the present invention will become immediately apparent to those of ordinary skill in the art upon reading the disclosure to follow.

### BRIEF DESCRIPTION OF THE DRAWINGS

FIG. 1 is an illustration of a stent, in accordance with the prior art.

FIG. 2 is a schematic flat view of a stent, in accordance with an embodiment of the present invention.

FIG. 3 is a schematic cross-sectional view taken along line b-b of FIG. 2, in accordance with an embodiment of the present invention.

FIGS. 4A-4C are schematic flat views illustrating various layers within the stent of FIG. 2.

FIGS. 5A-5C are schematic illustrations of tubular medical devices, such as stents, in accordance with various embodiments of the present invention.

FIG. 6 is a schematic illustration of a fractal capacitor for use in a medical device like that of FIG. 5B, in accordance with an embodiment of the present invention.

FIGS. 7 is a schematic illustration of a tubular medical device, such as a stent, in accordance an embodiment of the present invention.

FIG. 8 is a schematic illustration of a coil wound around a hollow, rectangular, columnar substrate.

FIGS. 9A and 9B are schematic illustrations of balloons, in accordance with two embodiments of the present invention.

FIG. 10 is a schematic illustration of an LRC circuit.

FIG. 11 is a schematic cross-sectional view taken along line b-b of FIG. 2, and FIGS. 12A and 12B are schematic flat views illustrating various layers within the stent of FIG. 2, in accordance with an alternative embodiment of the present invention.

FIG. 13 is a schematic illustration of a half-wave rectifier.

FIG. 14 is a schematic illustration of a full-wave rectifier.

FIG. 15 is a schematic illustration of a tubular medical device, such as a stent, in accordance with an embodiment of the present invention.

FIGS. 16A and 16B are schematic illustrations of a sheath, in accordance with an embodiment of the present invention.

### DETAILED DESCRIPTION

According to an aspect of the present invention, medical devices are provided which contain at least one electrical circuit that is at least partially formed from one or more multilayer regions. The multilayer regions may contain, for example, (a) a plurality of polyelectroyte layers, which contain one or more types of polyelectrolytes and/or (b) a plurality of particle layers, which contain one or more types of charged particles. The multilayer regions may be, for example, electrically conductive, semi-conductive, or insulating in nature. (As defined herein, conductors range from 10⁻⁶ to 10⁻⁴ ohm-cm in bulk resistivity, semiconductors range from 10⁻⁴ to 10³ ohm-cm, and insulators range from 10³ to 10²² ohm-cm.) Consequently, the multilayer regions may be used to construct a number of electronic elements including conductors, resistors, capacitors, inductors and/or diodes.

Specific examples of medical devices in accordance with the present invention are many and include medical devices which are adapted for implantation or insertion into a subject, for example, catheters (e.g., renal catheters or vascular catheters such as balloon catheters), stent delivery catheters (e.g., those configured for delivery of balloon expandable and self-expanding stents), guide wires, balloons, filters (e.g., vena cava filters), stents (including coronary vascular stents, cerebral, urethral, ureteral, biliary, tracheal, gastrointestinal and esophageal stents), stent grafts, cerebral aneurysm filler coils (including Guglilmi detachable coils and metal coils), vascular grafts, myocardial plugs, patches, pacemakers and pacemaker leads, heart valves, vascular valves, biopsy devices, patches, and tissue engineering scaffolds for cartilage, bone, skin and other in vivo tissue regeneration, among other devices.

The medical devices of the present invention include medical devices that are used for diagnostics, for systemic treatment, or for the localized treatment of any mammalian tissue or organ. Examples include tumors; organs including the heart, coronary and peripheral vascular system (referred to overall as “the vasculature”), lungs, trachea, esophagus, brain, liver, kidney, bladder, urethra and ureters, eye, intestines, stomach, pancreas, ovary, and prostate; skeletal muscle; smooth muscle; breast; dermal tissue; cartilage; and bone. As used herein, “treatment” refers to the prevention of a disease or condition, the reduction or elimination of symptoms associated with a disease or condition, or the substantial or complete elimination a disease or condition. Typical subjects are mammalian subjects, and more typically human subjects.

Several examples of medical devices which offer enhanced performance under magnetic resonance imaging (MRI) will now be discussed. MRI is a non-invasive technique that uses a magnetic field and radiofrequency waves to image the body. In MRI procedures, the patient is exposed to a magnetic field, which causes atoms in the patient's body having a net spin to precess around the magnetic field lines. Incident radio waves are then directed at the patient, and the incident radio waves interact by resonance with the precessing atoms in the patient's body having the same precessing frequency as the incident RF waves, forcing them to absorb energy from the radiowave and step to a higher quantum energy level. The decay in energy level after the RF pulse stops results in characteristic return radio waves. Typically one uses the frequency band of hydrogen atoms, but other atoms with a net spin can be used as well. The return radio waves are detected by a scanner and processed by a computer to generate an image of the body.

It is desirable in some cases to view the inside of a medical device. For example, it may be desirable to view the inside of a vascular stent for blockages, such as plaques, fatty tissue, etc., to view the inside of vascular grafts for evidence of endothelialization, and so forth. Unfortunately, stents and other metallic implants can cause a partial shielding from the incident radio waves by the Faraday Effect. In the case of vascular stents, these are not ideal but are rather partial Faraday cages, so a small percentage of the radio waves are able to pass to and from the interior, but not enough to give a reasonable MRI visibility.

One solution is to raise the energy of the radio waves to such high levels that enough energy remains, even after passing through the partial shielding of the device, to give reasonable MRI visibility. Unfortunately, this will cause the body to be heated to unacceptably high levels (much like heating in a microwave) as the absorbed RF energy is dissipated into heat.

In the present invention, on the other hand, the implant may be positioned inside of the field of a local (i.e., implanted) resonating circuit, which is tuned to the frequency of the MRI system. A typical resonating circuit consists at least one inductive element (e.g., a coil) and at least one capacitive element. During MRI scanning the RF-field (as sent out by the MRI unit) is magnified inside the coil of the local resonating circuit. Consequently, only the energy level at the position of the implant is increased, keeping the dissipation of energy in other parts of the body below acceptable levels. Moreover, in the case of stents and other vascular implants, the generated heat may be efficiently removed by convection (i.e., by blood flow).

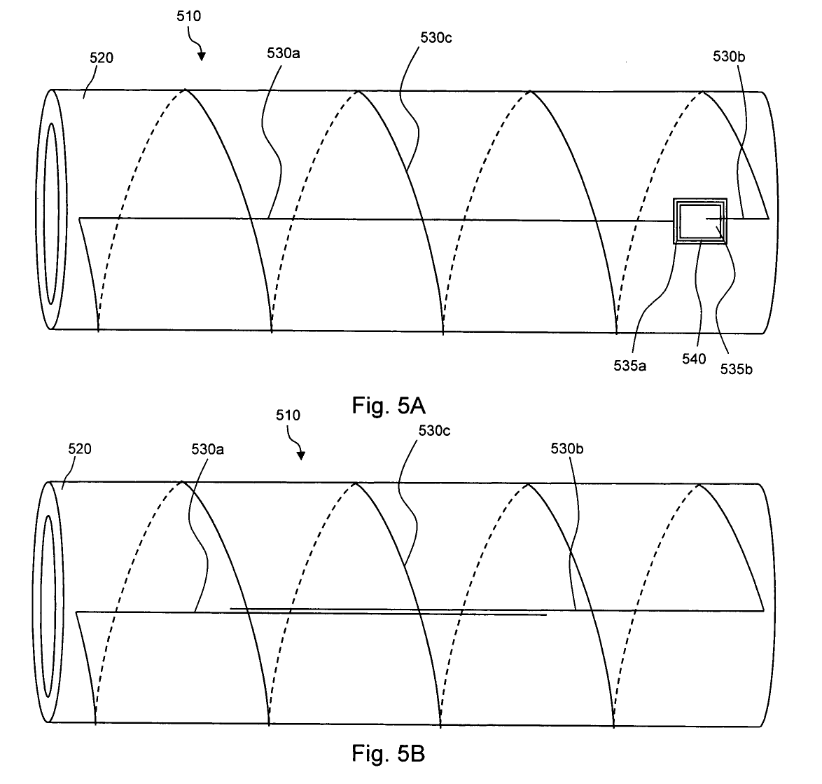

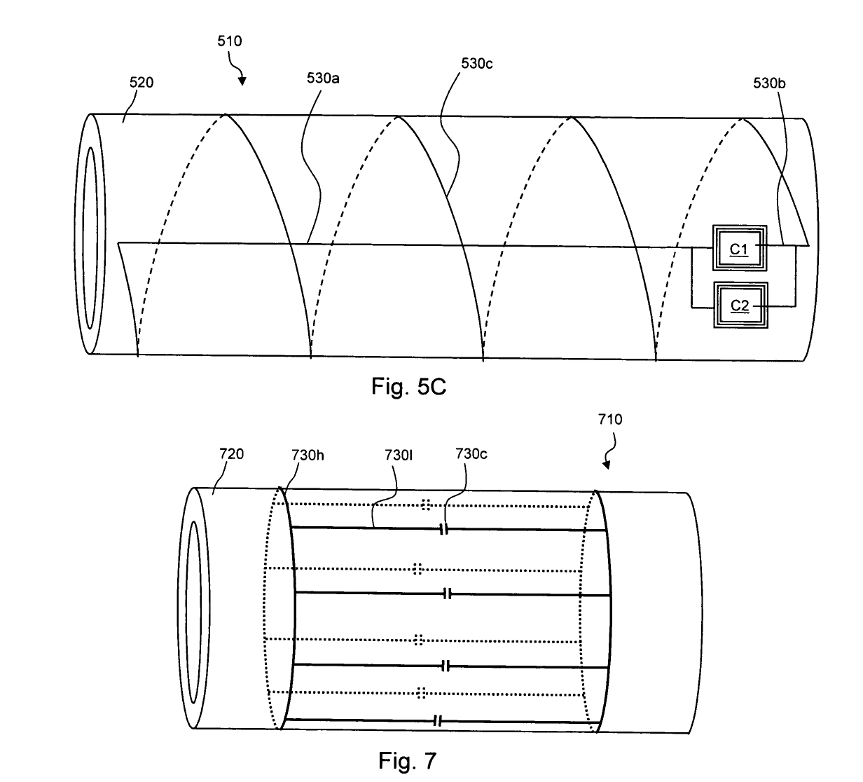

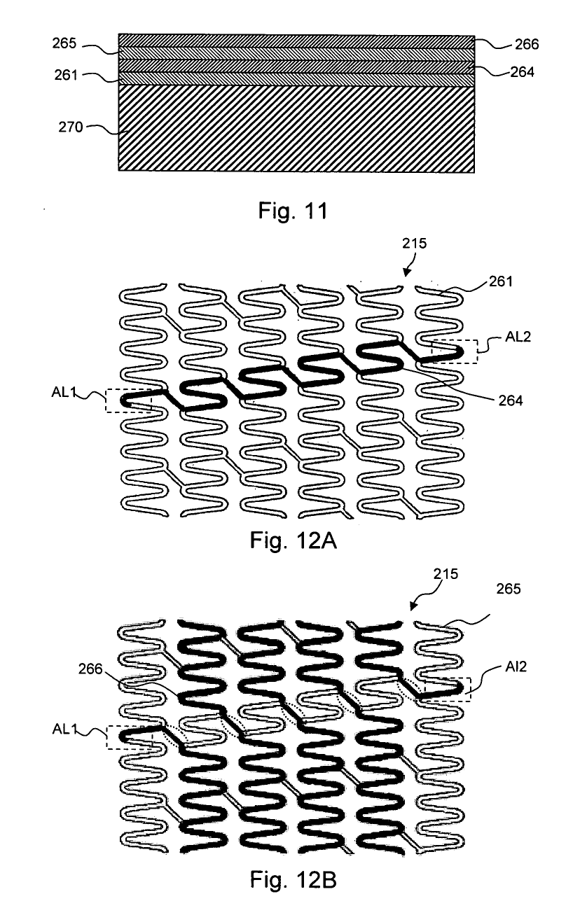

A medical device of this type in accordance with an embodiment of the invention, will now be discussed with reference to FIG. 5A. Medical device 510 (e.g., a portion of a ureteral stent, a sheath for an expandable vascular stent, etc.) comprises a substrate portion 520, which may act as a partial Faraday cage and thus reduce MRI visibility within. Upon the outer surface of the substrate portion 520 is provided a resonating circuit which includes a conductive coil portion 530c (shown with four windings, but any number of windings may be provided), a first longitudinal conductive element 530a, which extends from the left end of the coil portion 530c to make electrical contact with a lower capacitor plate 535a, and a second longitudinal conductive element 530b, which extends from the right end of the coil portion 530c to make electrical contact with an upper capacitor plate 535b. Between the capacitor plates 535a,535b, is provided a dielectric layer 540. The resulting circuit may be approximated by the equivalent circuit of FIG. 10, which contains a resistor R, a capacitor C and an inductor L.

The conductive coil portion 530c and first and second longitudinal conductive elements 530a and 530b may be provided using layer-by-layer techniques as discussed in more detail below. Films produced by these techniques have been demonstrated to be ultrathin and flexible, and they capable of adhering well to complex three-dimensional shapes. These films may be created by a wide variety of techniques such as inkjet printing, micro-stamping, and dip-coating, among others. Complex and multilayer coating patterns with very small feature sizes can be realized.

The capacitor is shown in FIG. 5A with progressively smaller plates/layers 535a,540,535b to aid in illustration, although these elements 535a,540,535b, are generally of the same surface area. Capacitance for a parallel plate capacitor may be given by the following equation: C=∈A/d, where ∈ is the permittivity of the material between the plates, A is the surface area of each of the plates, and d is the thickness of the material between the plates.

The capacitor may be, for example, a conventional surface-mountable capacitor. Alternatively, the capacitor may be deposited on the device surface using various techniques.

For example, an all-polymer capacitor may be constructed by utilizing the technology as described in Yi Liu et al., “All-polymer capacitor fabricated with inkjet printing technique,” Solid-State Electronics 47 (2003) 1543-1548. Yi Liu et al. use the conductive polymer, poly(3,4-ethylenedioxythiophene), doped with poly(styrene sulfonic acid) (Bayton P from Bayer Company) as the plate (electrode) portions of the capacitor. Poly(biphenyltetracarboxylic dianhydride-co-phenylenediamine) (PBPDA-PD) (from Aldrich company) is used as the insulating material for the dielectric layer, because PBPDA-PI) forms insoluble polyimide (PI) upon heating. PI is a very good insulator that is widely used in thin films due to its high dielectric strength of around 22 kV/mm.

In another alternative, at least a portion of the capacitor may be formed using layer-by-layer techniques. For example, instead of depositing PEDOT/PSS as described in Yi Liu et al., one may use layer-by-layer-deposited metallic plates as electrodes, for example, using techniques such as those described in the Yanjing Liu et al. reference discussed in detail below. For instance, the capacitor in Yi Liu et al. displays a 53 pF value for a 4 mm² area, but this value is expected by Yi Liu et al. to increase to more than 300 pF when using metallic electrodes.

In another alternative, an entire capacitor may be constructed using layer-by-layer techniques. Layer-by-layer techniques are capable of forming extremely thin layers with exquisite thickness control, thereby reducing the plate area need to achieve a given capacitance. For example, layer-by-layer-deposited metallic regions may be employed as electrodes, whereas layer-by-layer-deposited polymers may be employed as the dielectric material between the electrodes, for example, using techniques such as those as described in the A. A. Antipov et al. reference discussed below.

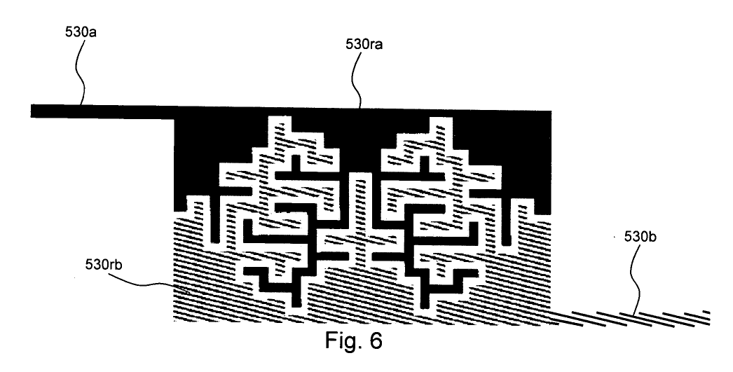

An alternative design to FIG. 5A is illustrated in FIG. 5B, in which the capacitive element is provided by forming a region where conductive elements 530la, 530lb run parallel to one another in a closely spaced-apart configuration. To the extent that the interfacial area between the conductive elements 530a, 530b is insufficient to generate a sufficient capacitance for a given application, this area may be increased significantly by the use of conductive plates 530ra,530rb such as those illustrated in FIG. 6. The plates 530ra,530rb are based on a fractal based design, as described in H. Samavati et al., “Fractal Capacitors,” IEEE Journal of Solid-State Circuits, Vol. 33, No. 12, December 1998, pp. 2035-2041, but other analogous designs are obviously possible. Such capacitors are desirable in certain embodiments, as the capacitor electrodes are within a single plane, simplifying construction in some cases.

Although a single capacitive element is illustrated in the preceding drawings, multiple capacitive elements C1,C2, etc. may be employed in parallel within the circuit as illustrated in FIG. 5C.

As with the capacitive elements, the inductive components may vary in number and type. With respect to number, 2, 3, 4, etc. inductors may be employed in series within the circuit. With respect to type, although the inductive element of FIGS. 5A-5C are in the form of helical coils (sometimes referred to as solenoid coils), other coils known in the MRI imaging art may be employed, including coils that do not advance helically down a cylinder, but rather are wound in the same longitudinal position for one or more windings, analogous to a watch spring.

Moreover, while a single resonant circuit is described in the preceding discussions, multiple resonant circuited may be provided, for example, one with a first resonant frequency and another with a second resonance frequency. In this way, a given device may be screened by different MRI systems, for example, by both a 1.5 Tesla system and a 3 Tesla system.

More sophisticated resonator designs are also known including so-called birdcage resonators, among others. In this regard, FIG. 7 is a schematic illustration of a tubular medical device 710 in accordance with the invention, which comprises a substrate portion 720, and upon which is provided a birdcage resonator. The birdcage resonator shown contains two conductive hoops 730h, between which are disposed eight longitudinal conductive strips 730l, which have capacitive elements 730c provided along their lengths. Examples of capacitive elements are described above, and include parallel plate capacitors, parallel line capacitors, and fractal capacitors, among others. Although eight strips are shown in the embodiment illustrated, one of ordinary skill in the art will recognize that other numbers are possible.

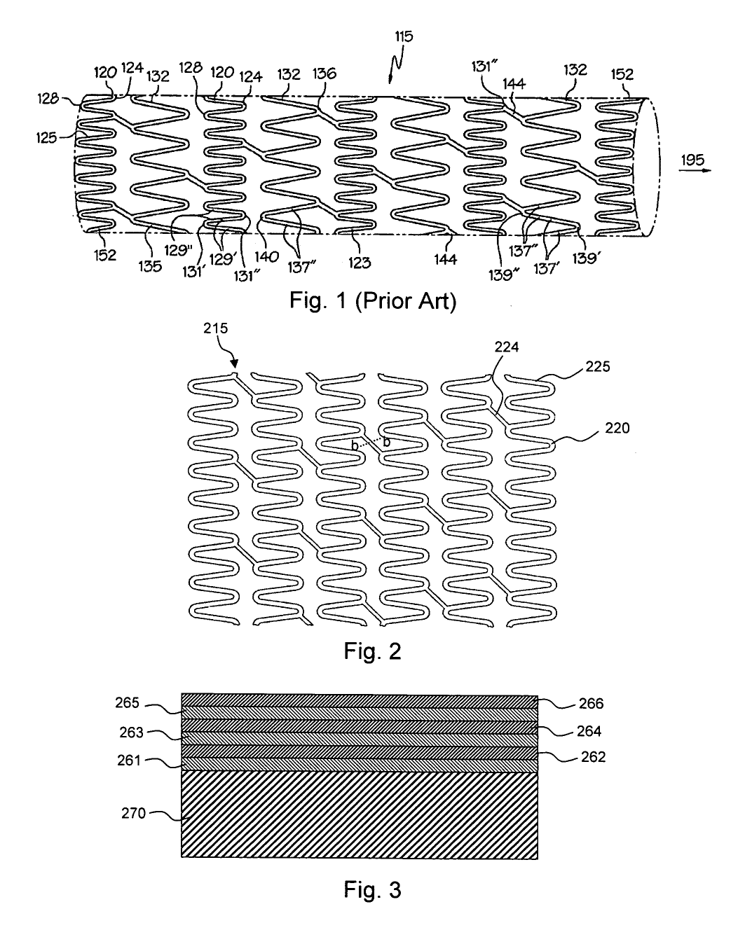

Further examples will now be described in conjunction with a stent structure analogous to that shown in FIG. 1. As described in more detail in U.S. Patent Pub. No. 2004/0181276, the stent of FIG. 1 comprises cylindrical shaped first segments 120 which are defined by an undulating pattern of interconnected paired first struts 123 in which adjacent pairs of first struts 129′ and 129″ in a given first segment 120 are interconnected at opposite ends 131′ and 131″, respectively. The undulations are characterized by a plurality of peaks 124 and troughs 128 taking a generally longitudinal direction along the cylinder surface such that the waves in first segments 120 open as the stent is expanded from an unexpanded state having a first diameter to an expanded state having a second diameter. The stent further comprises one or more cylindrical shaped second segments 132, each second segment being defined by a member formed in an undulating pattern of interconnected paired second struts 135 and in which adjacent pairs of second struts 137′ and 137″ in a given second segment 132 are interconnected at opposite ends 139′ and 139″, respectively. The undulations in the second segments are characterized by a plurality of peaks 136 and troughs 140 taking a generally longitudinal direction along the cylinder such that the waves in the second segments 132 open as the stent is expanded from an unexpanded state having a first diameter to an expanded state having a second diameter. First segments 120 are formed of a number of first struts 123 and second segments 132 formed of a number of second struts 135. First struts 123 are shorter than second struts 135. First and second segments 120 and 132 are aligned on a common longitudinal axis 195 to define a generally tubular stent body, shown generally at 115, having ends 152. First and second segments 120 and 132 alternate along the stent body. Adjacent first and second segments 120 and 132 are connected by a plurality of interconnecting elements 144. Each interconnecting element 144 extends from an end 131″ of paired first struts on a first segment 120 to an end 139″ of paired second struts on an adjacent second segment 132. The ends of interconnecting elements 144 are circumferentially offset relative to each other.

As mentioned above, one way of providing a resonator in conjunction with a stent of this type is to provide inductive and capacitive elements (e.g., like those described above in conjunction FIGS. 5A-C, 6 or 7) over a sheath that expands as the stent expands. For example, the circuit may be deposited on the sheath while it is maintained at an expanded diameter.

In another embodiment, circuit components are distributed between two sheaths. For example, one sheath can be formed which contains the inductive element and a portion of a capacitive element (e.g., one plate of the capacitor). Another sheath is also provided which has a second plate of the capacitor. The plates are arranged such that they are capable of facing one another, with a dielectric material disposed between them, when one sheath is inserted inside the other. For example, a plate may be provided on the outside of the inner sheath and on the inside of the outer sheath, with a dielectric mater deposited over one or both of the plates. The sheaths are electrically connected, for example, using a wire, as needed to complete the circuit. In such an arrangement, the capacitance (and consequently the resonant frequency) may be adjusted by moving one sheath longitudinally with respect to the other, thereby increasing or decreasing the effective plate area of the capacitor. For example, one can alter the self resonance frequency of the circuit by pulling the sheaths out of each other, reducing the effective capacitor area. If the capacitor surface area is too large to begin with, then one will always pass through self resonance point while pulling.

In another embodiment, a similar effect is achieved with a single sheath. Turning now to FIG. 16A, there is illustrated a sheath 1620, having first and second coil portions 1630a,1630b and having first and second capacitor plates 1640a,1640b. By making a double fold in the middle of the sheath 1620, for example, along the two dashed lines shown in the center of the sheath, then the right side of the sheath can be partially inserted into the left side as illustrated in FIG. 16B, such that the capacitor plate 1640b (hidden from view in FIG. 16B) is positioned under the capacitor plate 1640a with the sheath material acting as a dielectric between the plates. The capacitance of the thus-formed capacitor may be reduced by slowly withdrawing the right hand portion of the sheath from the left hand portion, reducing the overlap area between the plates 1640a,1640b.

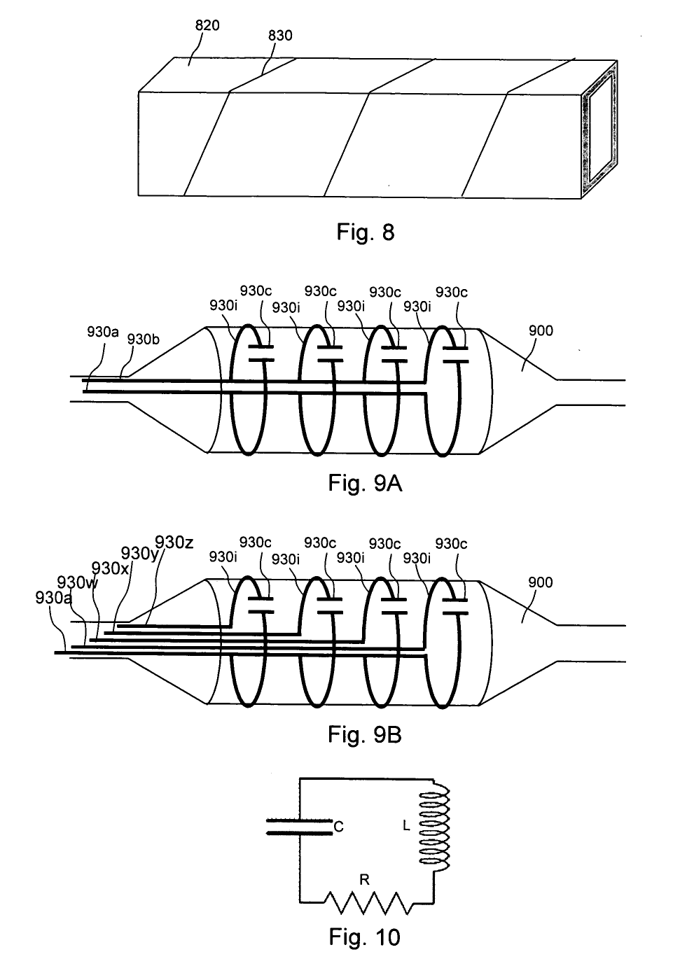

Moreover, although helical coils with constant or gradually changing curvature may be preferred in some embodiments, in other embodiments, coils may be employed in which the curvature is not constant or gradually changing. For example, the underlying substrate may have one or more flat surfaces. In this regard, see, e.g., FIG. 8, in which a coil 830 is wound around a hollow, rectangular, columnar substrate 820.

Coils of non-constant curvature may also be employed to provide a resonator on the surface of a stent like that of FIG. 1. In particular, FIG. 2 is a flat view of a stent 215 (i.e., the view is presented as if a generally cylindrical stent 215 were cut longitudinally and unrolled). Like the stent 115 of FIG. 1, stent 215 of FIG. 2 comprises a plurality of segments 220, which are defined by an undulating pattern of interconnected struts 225, and which are interconnected by a plurality of interconnecting elements 244. Unlike the stent 115 of FIG. 1, however, the stent segments 220 in FIG. 2 each have struts that are of the same length. More importantly, as seen from the cross-section of FIG. 2B, which is taken along line b-b of FIG. 2, in addition to a stent body material 270 (e.g., a biostable or biodegradable material), stent 215 also contains various electrically insulating layers 261, 263, 265 and various electrically conductive layers 262, 264, 266.

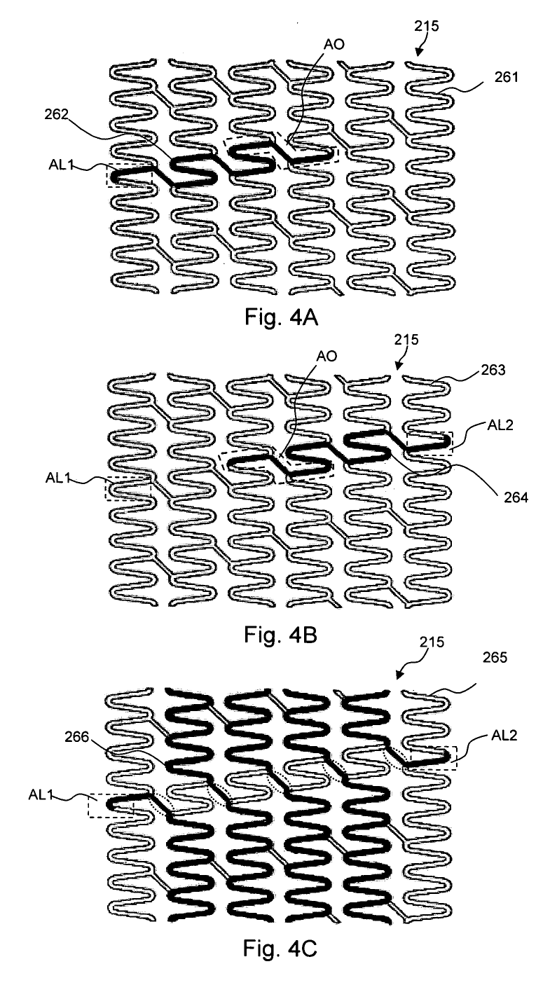

This particular embodiment of the invention may be explained in conjunction with FIGS. 4A-4C. After applying a first electrically insulating layer 261 to the outer surface of the stent, a first electrically conductive layer 262 is applied as illustrated in black in FIG. 4A. Also shown is an interlayer contact area AL1 and an overlap area AO, which will be explained below.

A second electrically insulating layer 263 is then applied, except in interlayer contact area AL1, followed by the application of a second electrically conductive layer 264 as illustrated in black in FIG. 4B. Note that conductive layer 264 lies over conductive layer 262 (separated by insulating layer 263) in overlap area AO, thereby forming a capacitive structure. A capacitive structure could also be alternatively formed in a single layer by arranging the conductive layers 262 and 264 in a manner analogous to those shown in FIGS. 5B and 6, if desired, simplifying processing. As yet another alternative, a thin, prefabricated, surface mount capacitor may also be employed.

A third electrically insulating layer 265 is then applied over the structure, except in interlayer contact areas AL1 and AL2, and a third electrically conductive layer 266 is formed as illustrated in black in FIG. 4C. Due to the absence of insulating layer material in areas AL1 and AL2, contact is made between the third electrically conductive layer 266 and the first electrically conductive layer 262 in area AL1, and between the third electrically conductive layer 266 and the second electrically conductive layer 264 in area AL2. Recalling that the stent 215 is cylindrical (i.e., FIGS. 4A-4C are flat views of the same), it can be seen that third electrically conductive layer 256 forms approximately four loops around the stent 215, yielding a structure with inductive characteristics.

As noted above, the overlap in area AO between the conductive layers 262 and 264, which are separated by insulating layer 263, forms a structure with capacitive characteristics. It is further noted that in the regions designated by dashed-line ovals in FIG. 4C, there is overlap between the third conductive layer 266 and either the first conductive layer 262 (within intervening insulating layers 263,265) or the second conductive layer 264 (within intervening insulating layer 265), leading to capacitive effects. These may be minimized, for example, by ensuring that the insulating layer 265 is sufficiently thick (capacitance is inversely proportional to the thickness of the insulating layer between the conductive layers).

Alternatively, in some embodiments, the need for a discrete capacitor is avoided by distributing the desired capacitance along the struts based on these areas of overlap. For example, referring now to FIGS. 11, 12A and 12B, after applying a first electrically insulating layer 261 to the outer surface of the stent 270, a first electrically conductive layer 264 is applied as illustrated in black in FIG. 12A. Also shown are interlayer contact areas AL1 and AL2. A second electrically insulating layer 265 is then applied over the structure, except in interlayer contact areas AL1 and AL2, and a second electrically conductive layer 266 is formed as illustrated in black in FIG. 12B. Due to the absence of insulating layer material in areas AL1 and AL2, contact is made between the second electrically conductive layer 266 and the first electrically conductive layer 264 in areas AL1 and AL2. As above, electrically conductive layer 256 forms approximately four loops around the stent 215, yielding a structure with inductive characteristics. In the regions designated by dashed-line ovals in FIG. 12B, there is overlap between the second conductive layer 266 and the first conductive layer 264 (within intervening insulating layer 265), creating capacitive regions. The capacitance of these regions may be increased, for example, by decreasing the thickness of the intervening insulating layer 265, by increasing the width of the conductive layers 264, 266, or a combination thereof. Conversely, the capacitance of these regions may be decreased, for example, by increasing the thickness of the intervening insulating layer 265, by decreasing the width of the conductive layers 264, 266, or a combination thereof.

Because resonating circuits are known to generate heat at the resonant frequency, heat may be generated within a hollow medical devices for purposes other than, or in addition to, imaging. For example, such circuits may be used to heat self-expanding stents.

As another example, a narrow polymer tube may be provided with a resonator like those described above on its interior (e.g., by forming suitable conductive and insulating layers on a flat substrate sheet, rolling the sheet into the shape of a tube, and making electrical connections and substrate-substrate bonds (e.g., joining the edges of the substrate to stabilized the tube) as needed. Subsequently, a drug release layer is coated on top of the circuit, whose release profile is influenced by heat. For example, D. Needham et al., “The development and testing of a new temperature-sensitive drug delivery system for the treatment of solid tumors,” Advanced Drug Delivery Reviews 53 (2001) 285-305, describe temperature-sensitive, liposome-based drug delivery systems which initiate drug release at temperatures just above body temperature. Given the very sharp temperature transitions that can achieved and the fact that drug release can be initiated at temperatures below 42° C., such systems are ideal for drug release into the bloodstream.

In other embodiments, such devices may be used, for example, for subcutaneous implants outside of the vasculature, where easier access may be made to small local RF fields, where the heat is not substantially dissipated by blood flow, and where the risks of inducing thrombosis are minimized.

Additional circuit components that may be formed by layer-by-layer technology include diodes, which may be formed, for example, from alternating layers of semiconductor particles (e.g., group IV semiconductors such as silicon or germanium, III-V semiconductors such as GaAs, and II-VI semiconductors such as ZnSe, among others, which may be doped). In this regard, see, e.g., B. Hemtanon et al., “Nanoparticle diode with Layer-by-layer deposition technique,” 2nd ECTI Annual Conference (ECTI-CON 2005), Pattaya, Thailand, 12-13 May 2005, in which films demonstrating diode characteristics were formed from alternating dip-coated layers of polyacrylic acid (PAA) and Mn-doped ZnS nanoparticles (˜30 nm) (capped with chitosan).

For example, an implantable device such as a stent may be constructed with a circuit comprising an inductive coil and a diode-based rectifier. The inductive coil enables coupling of RF energy exterior to the device (and exterior to the subject) into the device. For example, a source of RF energy may be coupled to a first coil outside the body, thereby creating a changing (e.g., sinusoidal) magnetic field which can induce a changing voltage across a second coil (e.g., the coil within the device). This voltage, in turn, can be converted into DC voltage using various known rectifier configurations.

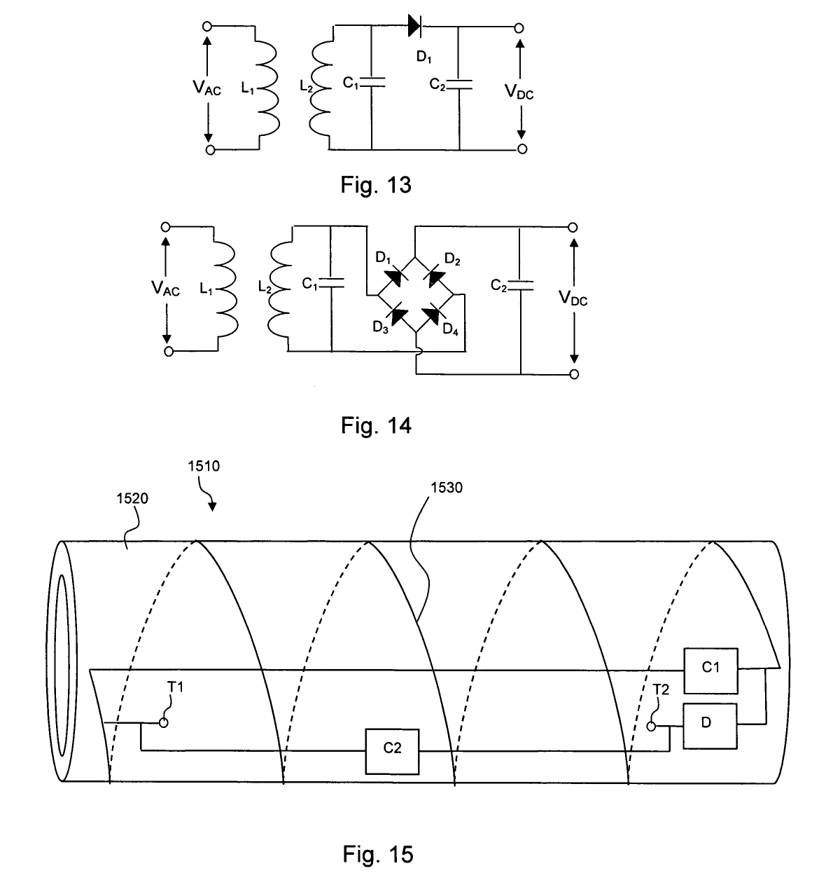

A specific example of a circuit designs for such a device is illustrated in FIG. 13, which utilizes a half-wave rectifier. The specific circuit shown includes a first external coil L₁, a second internal coil L₂ (associated with the device) and a diode D₁ (also associated with the device). Optional capacitors may also be provided, for example, a capacitor C₁, for tuning the receiving frequency of the circuit, and a capacitor C₂, which acts as a filtering capacitor for smoothing the DC output. A full-wave rectifier circuit is illustrated in FIG. 14, where L₁, L₂, D₁, C₁, and C₂ are as in FIG. 13. However, the device of FIG. 14 further includes diodes D₂, D₃, D₄, which along with diode D₁ provide full-wave rectification.

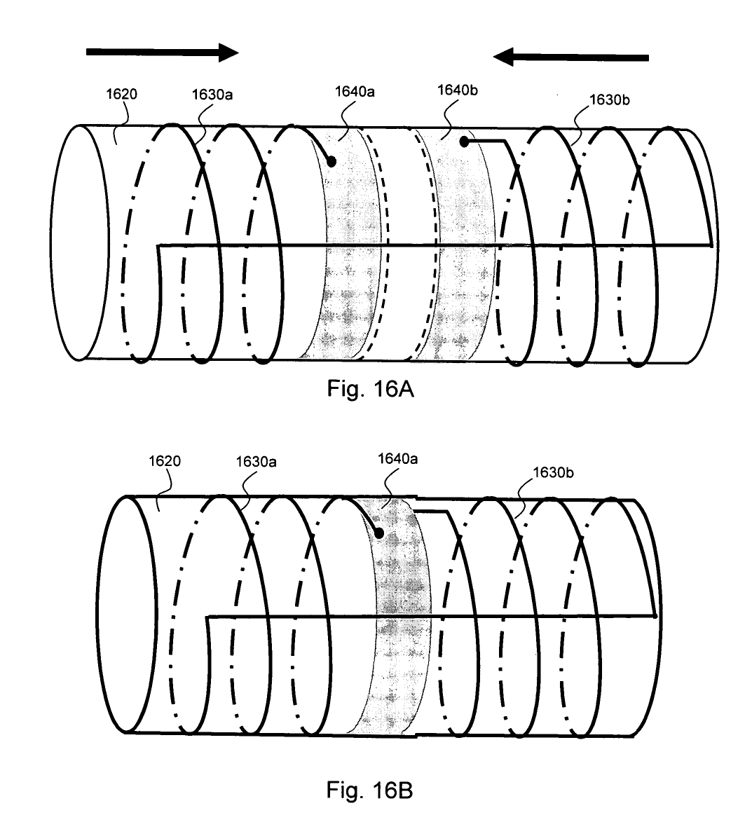

Such devices may be formed using layer-by-layer conductive, insulating, and rectifying films, for example, as described elsewhere herein. For example, a medical device having an effective circuit like that of FIG. 13 is schematically shown in FIG. 15. Analogous to FIG. 5A above, device 1510 comprises a substrate portion 1520, a conductive coil portion 1530, and a capacitive portion C1 (which establishes a resonance frequency for the LC circuit) interconnected by various conductive elements (not numbered). Unlike the device of FIG. 5A, however, the device shown also comprises a diode portion D, which enables the device to output a DC (or substantially DC) signal across terminals T1 and T2. The device of FIG. 15 is further equipped with a filtering capacitor C2. Any or all of these components may be formed using layer-by-layer deposition techniques as described elsewhere herein.

The resulting DC voltage from these and other circuits may then be used for a variety of purposes. For example, the DC voltage may be sent though another coil, for example, one formed around the outside or inside of a stent such as that of FIG. 15 (additional coil not shown), thereby generating a constant local magnetic field in the stent's interior. This field may be used for a variety of purposes. As one example, magnetic drug particles flowing within the bloodstream may be collected at the device's interior, due to presences of the magnetic field. Examples of such particles include, for example, magnetic drug-loaded nanocapsules having a layer-by-layer shell, such as those described in U.S. Pat. App. No. 2005/0129727 to Weber et al., which is hereby incorporated by reference, among numerous other possibilities.

As another example, the rectified DC energy may be stored for subsequent use, for example, in a capacitor or in a battery. Such energy may be used, for example, in implantable drug pumps, among other uses.

As yet another example, the rectified DC energy may be used to actuate electroactive polymers. The electroactive polymers that are typically used in connection with the present invention are ionic EAPs, including conductive EAPs that feature a conjugated backbone (e.g., they have a backbone that comprises and alternating series of single and double carbon-carbon bonds). Some commonly known conductive polymers are polypyrroles, polyanilines, polythiophenes, polyethylenedioxythiophenes, poly(p-phenylene vinylene)s, polysulfones and polyacetylenes. Polypyrrole is one of the more stable of these polymers under physiological conditions. Known derivatives of polypyrrole include the following substituted polymers: poly(N-methylpyrrole), poly(N-butylpyrrole), poly[N-(2-cyanoethyl)pyrrole], poly[N-(2-carboxyethyl)pyrrole], poly(N-phenylpyrrole), poly[N-(6-hydroxyhexyl)pyrrole], and poly[N-(6-tetrahydropyranylhexyl)pyrrole], among others. Conductive copolymers may also be formed from the above and other monomers (e.g., from pyrrole monomers, aniline monomers, thiophene monomers, ethylenedioxythiophene monomers, p-phenylene vinylene monomers, sulfone monomers, acetylene monomers, etc). For instance, pyrrole copolymers can be formed, for example, from two or more of the following monomers: pyrrole, 1-(2-cyanoethyl)pyrrole, 1-phenylpyrrole, 3-(acetic acid)pyrrole, 1-(propionic acid)pyrrole, and the pentafluorophenol ester of the same, among others. Specific examples include, for example poly[pyrrole-co-3-(acetic acid)pyrrole], poly[pyrrole-co-1-(propionic acid)pyrrole], poly[pyrrole-co-1-(propionic acid)pyrrole pentafluorophenol ester], poly[pyrrole-co-1-(2-cyanoethyl)pyrrole] and poly(pyrrole-co-1-phenylpyrrole), among others. For further information, see, e.g., Glidle A. et al., “XPS assaying of electrodeposited copolymer composition to optimise sensor materials,” Journal of Electron Spectroscopy and Related Phenomena, 121 (2001) 131-148, which is incorporated by reference in its entirety.

Electrically conductive polymers are typically semi-conductors in their neutral state. However, upon oxidation or reduction of the polymer to a charged state (e.g., polypyrrole is positively charged when oxidized and is neutral when reduced), the electrical conductivity is understood to be changed from a semi-conductive regime to a semi-metallic regime. Oxidation and reduction are believed to lead to charge imbalances that, in turn, can result in a flow of ions into or out of the material. These ions typically enter/exit the material from/into an ionically conductive medium associated with the polymer. For example, it is well known that dimensional changes are effectuated in electroactive polymers (EAPs), including conductive polymers, by the mass transfer of the ions (which are surrounded by a shell of water molecules, commonly referred to as the “hydration shell”) into or out of the polymers. This ion movement results in expansion or contraction of the polymer, which can deliver significant stresses (e.g., on the order of 1 MPa) and strains (e.g., on the order of 30%) for mechanical actuation purposes. Moreover, the fact that oxidation and reduction of conductive polymers is associated with the flow of ions into or out of the material, makes these materials useful for retention and/or delivery of charged therapeutic agents.

For example, redox switching of conductive polymers may allow a number of different oxidation states to be accessible. These redox states are stabilized by charge-balancing counter ions (often called dopant ions), which move in and out of the polymer during electrochemical switching. As a specific example, a variety of charge-balancing anions, including negatively charged therapeutic agents, may be associated with an oxidized, positively charged, conductive polymer, such as polypyrrole. However, by reducing/neutralizing the polymer, a net negative charge develops within the polymer, resulting in expulsion of the anions from the polymer. Further information regarding the use of conductive polymers for ion delivery can be found, for example, U.S. Patent Appln. Pub. No. 2002/0022826 which is incorporated by reference in its entirety. See also H. Huang et al., “Probe beam deflection study on electrochemically controlled release of 5-Fuorouracil,” Electrochimica Acta, Vol. 43, No. 9, pp. 999-1004, 1998; S.-K. Lee et al., “Experimental Analysis on the Properties of Polypyrrole as Drug Delivery System Materials,” Smart Structures and Materials 2003: Electroactive Polymer Actuators and Devices (EAPAD), Yoseph Bar-Cohen, Editor, Proceedings of SPIE Vol. 5051 (2003) which describes the delivery of charged drugs such as salicylate and epinephrine from polypyrrole; R. L. Blankspoor and L. L. Miller, “Polymerized 3-Methoxythiophene. A Processable Material for the Controlled Release of Anions,” J. Chem. Soc., Chem. Commun., pp. 90-92 (1985) which describes the delivery of glutamate ions from 3-methoxythiophene; A.-C. Chang and L. L. Miller, “Electrochemically Controlled Binding and Release of Salicylate, TCNQ′⁻ and Ferrocyanide from Films of Oligomeric 3-Methoxythiophene,” J. Electroanal. Chem., 247 (1988) 173-184; B. Zinger and L. L. Miller, “Timed Release of Chemicals from Polypyrrole Films,” J. Am. Chem. Soc. 1984, 106, 6861-6863, which describes the release of glutamate ions from polypyrrole; B. Pirot et al., “Electrochemical method for entrapment of oligonucleotides in polymer-coated electrodes,” J. Biomed. Mater. Res., 1999, 46(4), 566-72, which describes the incorporation of oligonucleotides into conducting films of poly(3,4-ethylene dioxythiophene)—the addition of neutral water soluble polymers such as poly(vinylpyrrolidone) or poly(ethylene glycol) resulted in higher incorporation yields of oligonucleotides. Each of these is incorporated by reference in its entirety.

The following elements are generally utilized to bring about electroactive polymer actuation: (a) a source of electrical potential, (b) an active region comprising the electroactive polymer, (c) a counter electrode and (d) an electrolyte in contact with both the active region and the counter electrode. The electrolyte, which is in contact with at least a portion of the surface of the active region, allows for the flow of ions and thus acts as a source/sink for the ions. The electrolyte may be, for example, a liquid, a gel, or a solid, so long as ion movement is permitted. For drug delivery purposes, physiological fluid adjacent to the active region may be used as the electrolyte. The counter electrode may be formed from any suitable electrical conductor, for example, a conducting polymer, a conducting gel, or a metallic region (e.g., a conductive layer by layer film, among others). At least a portion of the surface of the counter electrode is generally in contact with the electrolyte, in order to provide a return path for charge. Designs maximizing surface area contact with the electrolyte would optimize charge transfer and reduce activation time.

In accordance with the present invention, the DC voltage provided by circuits such as those described above, among others, may be used to generate DC electrical fields for activation of electroactive polymers such as those described above (e.g., polypyrrole or one of its derivatives, among others).

As a specific example, one of the terminals T1 of the device of FIG. 15 may be connected to a drug-loaded electroactive polymer disposed on the inside or outside surface of the stent, whereas the other terminal T2 may be connected to a counter electrode. This particular device utilizes physiological fluid as an intervening electrolyte, as discussed above. The drug-loaded electroactive polymer in this particular instance may be oxidized polypyrrole (which is positively charged) having an associated negatively charged drug. The diode component D of FIG. 15 in this example is oriented such that when a suitable external magnetic field is coupled to the coil 1530 within the device 1510, a DC voltage of a polarity and magnitude sufficient to reduce the polypyrrole is generated. Upon reduction/neutralization of the polymer, the negatively charged drug is expelled from the polymer, delivering the drug to the subject.

In another embodiment, two rectifying circuits are provided, each with its own resonance frequency, and each including, for example, a coil, a capacitor which establishes the resonance frequency for the circuit, an optional filtering capacitor, and at least one diode. The terminals of each of these circuits are electrically coupled to the electroactive polymer and to the counter electrode, but with opposite electrical bias. Consequently, one circuit may be activated when one wishes to oxidize the EAP, whereas the other circuit may be activated when one wishes to reduce the EAP. In this way, one can switch between oxidizing and reducing the EAP layer, allowing one to turn drug delivery on and off (or allowing one to mechanically actuate the EAP in a reversible manner).

Conductors, resistors, capacitors and/or inductors may also be formed in conjunction with other medical devices including implantable sensors and MEMS (micro-electro-mechanical systems) devices, among others. For example, conductive traces may be provided to transmit electrical power and signals, may provide electrical shielding, or may be provided in the form of antennas for signal reception and transmission, among other functions.

In other embodiments of the invention, resonating circuits are used to provide feedback to a physician as to the precise diameter of a balloon at multiple locations along its length during a lesion dilatation or during stent deployment. In this regard, multilayer constructions in accordance with the invention can be used to provide an electronic signal as to the state of balloon inflation, without detracting from catheter performance, including shaft push or track performance. This may eliminate the need for contrast agent and exposure of the patient and catheter lab personnel to x-rays during x-ray fluoroscopy which is currently used to visualize the opening of the balloon or stent.

Turning now to FIG. 9A, a cylindrical balloon 900 having conical tapered ends is illustrated schematically, in accordance with an embodiment of the invention. On the surface of the balloon 900 are transmission lines 930a and 930b, inductive elements 930i and capacitive elements 930c. Such elements may be formed from one or more conductive-particle-containing multilayer regions as described above, using insulating layers where appropriate.

The result is that several LRC circuits containing inductive, capacitive and resistive (inherently or intentionally introduced) components may be created along the length of the balloon (four circuits are shown, although other numbers, including one, two, three, five, six, seven, eight or more circuits may be created), which may be provided, for example, through layer-by-layer deposition, or otherwise deposited as described above. As the balloon expands, so will the diameter of the coils, which will result in a shift in the resonance frequency of the LRC circuits. Measuring the resonance frequency or phase shift of each coil will allow one to determine the dilatation pattern of the balloon, with a reasonably large Q factor being preferred to allow better to measure the exact coil diameter. The design of FIG. 9A is simple, with only two transmission lines 930a, 930b extending to the outside. By forming each capacitor with a different capacitance, each loop will have its own characteristic resonance frequency. By scanning along the frequency band (e.g., conducting a frequency ramp), the size of each individual loop can be determined. Of course, non-multiplexed designs are also possible, as each loop may also be provided with it's own transmission line, for example, in an arrangement such as that illustrated in FIG. 9B, with one common line 930a and individual lines 930w, 930x, 930y, 930z for each resonant circuit.

As noted above, electrical circuits for use in the present invention may be at least partially formed from one or more multilayer regions. The multilayer regions, in turn, contain a multiple layers of alternating charge, for example, (a) a plurality of polyelectroyte layers, which contain one or more types of polyelectrolytes and/or (b) a plurality of particle layers, which contain one or more types of charged particles. Such regions may be provided by a process known as layer-by-layer deposition.

In this regard, layer-by-layer deposition techniques may be used to coat a wide variety of substrate materials using charged materials via electrostatic self-assembly, which is generally understood to be based primarily on electrostatic interactions of oppositely charged ionic adsorbates. In a typical layer-by-layer technique, multilayer growth proceeds through sequential steps, in which the substrate is exposed to solutions or suspensions of cationic and anionic species, frequently with intermittent rinsing between steps. In this way, a first layer having a first surface charge is typically deposited (or adsorbed) on an underlying substrate, followed by a second layer having a second surface charge that is opposite in sign to the surface charge of the first layer, and so forth. The charge on the outer layer is reversed upon deposition of each sequential layer.

Multilayer regions created using layer-by-layer self-assembly commonly include one or more types of polyelectrolytes as ionic species. As used herein, “polyelectrolytes” are polymers having multiple (e.g., 5 to 10 to 25 to 50 to 100 to 250 to 500 to 1000 or more) charged groups (e.g., ionically dissociable groups that provide cations and anions). Frequently, the number of charged groups is so large that the polymers are soluble in polar solvents (including water) when in ionically dissociated form (also called polyions). Depending on the type of dissociable groups, polyelectrolytes may be classified as polyacids and polybases. When dissociated, polyacids form polyanions, with protons being split off. Polyacids include inorganic, organic and bio-polymers. Examples of polyacids are polyphosphoric acids, polyvinylsulfuric acids, polyvinylsulfonic acids, polyvinylphosphonic acids and polyacrylic acids. Examples of the corresponding salts, which are also called polysalts, are polyphosphates, polyvinylsulfates, polyvinylsulfonates, polyvinylphosphonates and polyacrylates. Polybases contain groups which are capable of accepting protons, e.g., by reaction with acids, with a salt being formed. Examples of polybases having dissociable groups within their backbone and/or side groups are polyallylamine, polyethylimine, polyvinylamine and polyvinylpyridine. By accepting protons, polybases form polycations. Polysalts dissociated to form either polycations or polyanions.

Some polyelectrolytes have both anionic and cationic groups, but nonetheless will have a net negative charge, for example, because the anionic groups outnumber the cationic groups, or will have a net positive charge, for example, because the cationic groups outnumber the anionic groups. In this regard, the net charge of a particular polyelectrolyte may change with the pH of its surrounding environment. Polyelectrolytes containing both cationic and anionic groups are categorized herein as either polycations or polyanions, depending on which groups predominate.

Thus, as defined herein, the term polyelectrolyte embraces a wide range of species, including polycations and their precursors (e.g., polybases, polysalts, etc.), polyanions and their precursors (e.g., polyacids, polysalts, etc.), polymers having multiple anionic and cationic groups (e.g., polymers having multiple acidic and basic groups including a variety of proteins), ionomers (polyelectrolytes in which a small but significant proportion of the constitutional units carry charges), and so forth. Moreover, suitable polyelectrolytes include low-molecular weight polyelectrolytes (e.g., polyelectrolytes having molecular weights of a few hundred Daltons or less) up to macromolecular polyelectrolytes (e.g., polyelectrolytes of synthetic or biological origin, which commonly have molecular weights of several million Daltons or more). Linear or branched polyelectrolytes may be used in some embodiments. Polyelectrolyte molecules may be crosslinked within and/or between the individual layers in some embodiments.

Suitable polycations may be selected, for example, from the following, among others: polyamines, including polyamidoamines, poly(amino methacrylates) including poly(dialkylaminoalkyl methacrylates) such as poly(dimethylaminoethyl methacrylate) and poly(diethylaminoethyl methacrylate), polyvinylamines, polyvinylpyridines including quaternary polyvinylpyridines such as poly(N-ethyl-4-vinylpyridine), poly(vinylbenzyltrimethylamines), polyallylamines such as poly(allylamine hydrochloride) (PAH) and poly(diallyldialklylamines) such as poly(diallyldimethylammonium chloride), spermine, spermidine, hexadimethrene bromide (polybrene), polyimines including polyalkyleneimines such as polyethyleneimines, polypropyleneimines and ethoxylated polyethyleneimines, basic peptides and proteins, including histone polypeptides and polymers containing lysine, arginine, ornithine and combinations thereof including poly-L-lysine, poly-D-lysine, poly-L,D-lysine, poly-L-arginine, poly-D-arginine, poly-D,L-arginine, poly-L-ornithine, poly-D-ornithine, poly-L,D-ornithine, gelatin, albumin, protamine and protamine sulfate, and polycationic polysaccharides such as cationic starch and chitosan, as well as copolymers, derivatives and combinations of the preceding, among various others.

Suitable polyanions may be selected, for example, from the following, among others: polysulfonates such as polyvinylsulfonates, poly(styrenesulfonates) such as poly(sodium styrenesulfonate) (PSS), sulfonated poly(tetrafluoroethylene), sulfonated polymers such as those described in U.S. Pat. No. 5,840,387, including sulfonated styrene-ethylene/butylene-styrene triblock copolymers, sulfonated styrenic homopolymers and copolymer such as a sulfonated versions of the polystyrene-polyolefin copolymers described in U.S. Pat. No. 6,545,097 to Pinchuk et al., which polymers may be sulfonated, for example, using the processes described in U.S. Pat. No. 5,840,387 and U.S. Pat. No. 5,468,574, as well as sulfonated versions of various other homopolymers and copolymers, polysulfates such as polyvinylsulfates, sulfated and non-sulfated glycosaminoglycans as well as certain proteoglycans, for example, heparin, heparin sulfate, chondroitin sulfate, keratan sulfate, dermatan sulfate, polycarboxylates such as acrylic acid polymers and salts thereof (e.g., ammonium, potassium, sodium, etc.), for instance, those available from Atofina and Polysciences Inc., methacrylic acid polymers and salts thereof (e.g., EUDRAGIT, a methacrylic acid and ethyl acrylate copolymer), carboxymethylcellulose, carboxymethylamylose and carboxylic acid derivatives of various other polymers, polyanionic peptides and proteins such as glutamic acid polymers and copolymers, aspartic acid polymers and copolymers, polymers and copolymers of uronic acids such as mannuronic acid, galatcuronic acid and guluronic acid, and their salts, for example, alginic acid and sodium alginate, hyaluronic acid, gelatin, and carrageenan, polyphosphates such as phosphoric acid derivatives of various polymers, polyphosphonates such as polyvinylphosphonates, polysulfates such as polyvinylsulfates, as well as copolymers, derivatives and combinations of the preceding, among various others.

With respect to the charged-particle-containing layers, the particles for use therein may vary widely in composition and size.

For example, a wide variety of particle types may be used in the charged particle layers of the present invention, including various metallic, ceramic and carbon particles, among others, with the selected type depending upon the electrical properties desired (e.g., conductive particles, semi-conductive particles, or insulating particles), among other factors (e.g., carbon nanotubes, in addition to being conductive or semiconductive, are also very high in strength).

Examples of particle types include biostable and bioabsorbable metal particles including substantially pure metal particles (e.g., biostable metal particles such as gold, platinum, palladium, iridium, osmium, rhodium, titanium, tantalum, tungsten, and ruthenium, and bioabsorbable metal particles such as magnesium and iron), metal particles of alloys comprising iron and chromium (e.g., stainless steels, including platinum-enriched radiopaque stainless steel), metal particles of alloys comprising nickel and titanium (e.g., Nitinol), metal particles of alloys comprising cobalt and chromium, including alloys that comprise cobalt, chromium and iron (e.g., elgiloy particles of alloys), alloys comprising nickel, cobalt and chromium (e.g., MP 35N) and alloys comprising cobalt, chromium, tungsten and nickel (e.g., L605), particles of alloys comprising nickel and chromium (e.g., inconel particles of alloys), bioabsorbable metal particles of alloys such as alloys of magnesium and iron (including their combinations with Ce, Ca, Zn, Zr and Li), alumina particles, titanium oxide particles, tungsten oxide particles, tantalum oxide particles, zirconium oxide particles, silica particles, silicate particles such as aluminum silicate particles, synthetic or natural phyllosilicates including clays and micas (which may optionally be intercalated and/or exfoliated) such as montmorillonite, hectorite, hydrotalcite, vermiculite and laponite, and including particulate molecules such as dendrimers, silicates such as polyhedral oligomeric silsequioxanes (POSS), including various functionalized POSS and polymerized POSS, polyoxometallates (e.g., Keggin-type, Dawson-type, Preyssler-type, etc.), fullerenes (e.g., “Buckey balls”), single-wall nanotubes and multi-wall carbon nanotubes (including so-called “few-wall” nanotubes).

In certain embodiments, the particles are nanoparticles in the sense that they have at least one major dimension (e.g., the thickness for a nanoplates, the diameter for a nanospheres, nanocylinders and nanotubes, etc.) that is less than 1000 nm, and more typically less than 100 nm. Hence, for example, nanoplates typically have at least one dimension (e.g., thickness) that is less than 1000 nm, other nanoparticles typically have at least two orthogonal dimensions (e.g., thickness and width for nano-ribbons, diameter for cylindrical and tubular nanoparticles, etc.) that are less than 1000 nm, while still other nanoparticles typically have three orthogonal dimensions that are less than 1000 nm (e.g., length, width and height for nanocubes, diameter for nanospheres, etc.).

In general, multilayer regions are formed upon an underlying substrate. For example, the multilayer regions may be formed directly on a medical device (e.g., a balloon or stent, among many others) or they may be formed on a substrate which is subsequently associated with a medical device. As one example, a fiber consisting of a conductive multilayer coating deposited on a biostable or degradable core (e.g., nylon or polyethylene glycol, among many others), may be arranged in the form of coil on a medical device surface.

Suitable substrates materials upon which the multilayer regions of the present invention may be formed may be selected from a variety of materials, including (a) organic materials (e.g., materials containing 50 wt % or more organic species) such as polymeric materials and (b) inorganic materials (e.g., materials containing 50 wt % or more inorganic species) such as metallic materials (e.g., metals and metal alloys) and non-metallic inorganic materials (e.g., carbon, semiconductors, glasses and ceramics, which may contain various metal- and non-metal-oxides, various metal- and non-metal-nitrides, various metal- and non-metal-carbides, various metal- and non-metal-borides, various metal- and non-metal-phosphates, and various metal- and non-metal-sulfides, among others).

Specific examples of non-metallic inorganic materials may be selected, for example, from materials containing one or more of the following: metal oxides, including aluminum oxides and transition metal oxides (e.g., oxides of titanium, zirconium, hafnium, tantalum, molybdenum, tungsten, rhenium, and iridium); silicon; silicon-based ceramics, such as those containing silicon nitrides, silicon carbides and silicon oxides (sometimes referred to as glass ceramics); calcium phosphate ceramics (e.g., hydroxyapatite); carbon and carbon-based, ceramic-like materials such as carbon nitrides, among many others.

Specific examples of metallic inorganic materials may be selected, for example, from substantially pure biostable and bioabsorbable metals (e.g., biostable metals such as gold, platinum, palladium, iridium, osmium, rhodium, titanium, tantalum, tungsten, and ruthenium, and bioresorbable metals such as magnesium and iron), metal alloys comprising iron and chromium (e.g., stainless steels, including platinum-enriched radiopaque stainless steel), alloys comprising nickel and titanium (e.g., Nitinol), alloys comprising cobalt and chromium, including alloys that comprise cobalt, chromium and iron (e.g., elgiloy alloys), alloys comprising nickel, cobalt and chromium (e.g., MP 35N) and alloys comprising cobalt, chromium, tungsten and nickel (e.g., L605), alloys comprising nickel and chromium (e.g., inconel alloys), and bioabsorbable metal alloys such as magnesium alloys and iron alloys (including their combinations with Ce, Ca, Zn, Zr and Li), among many others.

Specific examples of organic materials include polymers (biostable or biodegradable) and other high molecular weight organic materials, which may be selected, for example, from the following: polycarboxylic acid polymers and copolymers including polyacrylic acids; acetal polymers and copolymers; acrylate and methacrylate polymers and copolymers (e.g., n-butyl methacrylate); cellulosic polymers and copolymers, including cellulose acetates, cellulose nitrates, cellulose propionates, cellulose acetate butyrates, cellophanes, rayons, rayon triacetates, and cellulose ethers such as carboxymethyl celluloses and hydroxyalkyl celluloses; polyoxymethylene polymers and copolymers; polyimide polymers and copolymers such as polyether block imides, polyamidimides, polyesterimides, and polyetherimides; polysulfone polymers and copolymers including polyarylsulfones and polyethersulfones; polyamide polymers and copolymers including nylon 6,6, nylon 12, polyether-block co-polyamide polymers (e.g., Pebax® resins), polycaprolactams and polyacrylamides; resins including alkyd resins, phenolic resins, urea resins, melamine resins, epoxy resins, allyl resins and epoxide resins; polycarbonates; polyacrylonitriles; polyvinylpyrrolidones (cross-linked and otherwise); polymers and copolymers of vinyl monomers including polyvinyl alcohols, polyvinyl halides such as polyvinyl chlorides, ethylene-vinylacetate copolymers (EVA), polyvinylidene chlorides, polyvinyl ethers such as polyvinyl methyl ethers, vinyl aromatic polymers and copolymers such as polystyrenes, styrene-maleic anhydride copolymers, vinyl aromatic-hydrocarbon copolymers including styrene-butadiene copolymers, styrene-ethylene-butylene copolymers (e.g., a polystyrene-polyethylene/butylene-polystyrene (SEBS) copolymer, available as Kraton® G series polymers), styrene-isoprene copolymers (e.g., polystyrene-polyisoprene-polystyrene), acrylonitrile-styrene copolymers, acrylonitrile-butadiene-styrene copolymers, styrene-butadiene copolymers and styrene-isobutylene copolymers (e.g., polyisobutylene-polystyrene block copolymers such as SIBS), polyvinyl ketones, polyvinylcarbazoles, and polyvinyl esters such as polyvinyl acetates; polybenzimidazoles; ionomers; polyalkyl oxide polymers and copolymers including polyethylene oxides (PEO); polyesters including polyethylene terephthalates, polybutylene terephthalates and aliphatic polyesters such as polymers and copolymers of lactide (which includes lactic acid as well as d-,l- and meso lactide), epsilon-caprolactone, glycolide (including glycolic acid), hydroxybutyrate, hydroxyvalerate, para-dioxanone, trimethylene carbonate (and its alkyl derivatives), 1,4-dioxepan-2-one, 1,5-dioxepan-2-one, and 6,6-dimethyl-1,4-dioxan-2-one (a copolymer of polylactic acid and polycaprolactone is one specific example); polyether polymers and copolymers including polyarylethers such as polyphenylene ethers, polyether ketones, polyether ether ketones; polyphenylene sulfides; polyisocyanates; polyolefin polymers and copolymers, including polyalkylenes such as polypropylenes, polyethylenes (low and high density, low and high molecular weight), polybutylenes (such as polybut-1-ene and polyisobutylene), polyolefin elastomers (e.g., santoprene), ethylene propylene diene monomer (EPDM) rubbers, poly-4-methyl-pen-1-enes, ethylene-alpha-olefin copolymers, ethylene-methyl methacrylate copolymers and ethylene-vinyl acetate copolymers; fluorinated polymers and copolymers, including polytetrafluoroethylenes (PTFE), poly(tetrafluoroethylene-co-hexafluoropropene) (FEP), modified ethylene-tetrafluoroethylene copolymers (ETFE), and polyvinylidene fluorides (PVDF); silicone polymers and copolymers; polyurethanes; p-xylylene polymers; polyiminocarbonates; copoly(ether-esters) such as polyethylene oxide-polylactic acid copolymers; polyphosphazines; polyalkylene oxalates; polyoxaamides and polyoxaesters (including those containing amines and/or amido groups); polyorthoesters; biopolymers, such as polypeptides, proteins, polysaccharides and fatty acids (and esters thereof), including fibrin, fibrinogen, collagen, elastin, chitosan, gelatin, starch, glycosaminoglycans such as hyaluronic acid; as well as blends and further copolymers of the above.

Certain substrates are inherently charged and thus readily lend themselves to layer-by-layer assembly techniques.

Where the substrate is bioabsorbable (e.g., a bioabsorbable stent), the multilayer region may likewise be biodegradable, for example, through the use of biodegradable polyelectrolytes and biodegradable particles, including biodegradable insulating and conductive particles. Suitable materials may be selected from the biodegradable particles (e.g., Mg, Fe, Zn and Ca particle) and biodegradable polyelectrolytes (e.g., chitosan or cationic starch as a polycation and heparin as a polyanion) listed above, among others.

To the extent that the substrate does not have an inherent net surface charge, a surface charge may nonetheless be provided. For example, where the substrate to be coated is conductive, a surface charge may be provided by applying an electrical potential to the same.

As another example, substrates, including polymeric substrates, may be chemically treated with various reagents, including reducing agents and oxidizing agents (e.g., sulfur trioxide for sulfonate formation), which modify their surfaces so as to provide them charged groups, such as such as amino, phosphate, sulfate, sulfonate, phosphonates and carboxylate groups, among many others.

Other techniques for providing surface charge include techniques whereby a surface region is treated with a reactive plasma. For example, gas discharge techniques have been used to functionalize polymer surfaces. Surface modification is obtained by exposing the surface to a partially ionized gas (i.e., to a plasma). Two types of processes are frequently described, depending on the operating pressure: corona discharge techniques (which are conducted at atmospheric pressure) and glow discharge techniques (which are conducted at reduced pressure). Because the plasma phase consists of a wide spectrum of reactive species (electrons, ions, etc.) these techniques have been used widely for functionalization of polymer surfaces.

Glow discharge techniques may be preferred over corona discharge techniques in certain embodiments, because the shape of the object to be treated is of minor importance during glow discharge processes. Moreover, glow discharge techniques are usually either operated in an etching or in a depositing mode, depending on the gas used, whereas corona discharge techniques are usually operated in an etching mode. A commonly employed glow discharge technique is radio-frequency glow discharge (RFGD).

Lasers may also be used be used to create a localized plasma in the vicinity of the laser beam (e.g., just above the focal point of the beam).

Plasma treatment processes have been widely used to etch, crosslink and/or functionalize surfaces, with these processes occurring simultaneously at a surface that is exposed to a discharge of a non-polymerizable gas. The gas that is used primarily determines which of these processes is dominant. When gases like carbon monoxide (CO), carbon dioxide (CO₂), or oxygen (O₂) are used, functionalization with —COOH groups (which donate protons to form anionic groups) is commonly observed. When gases like ammonia, a propyl amine, or N₂/H₂ are employed, —NH₂ groups (which accept protons to form cationic groups) are commonly formed.

Functional group containing surfaces may also be obtained using plasma polymerization processes in which “monomers” are employed that contain functional groups. Allylamine (which produces —NH₂ groups) and acrylic acid (which produces —COOH groups) have been used for this purpose. By using a second feed gas (generally a non-polymerizable gas) in combination with the unsaturated monomer, it is possible to incorporate this second species in the plasma deposited layer. Examples of gas pairs include allylamine/NH₃ (which leads to enhanced production of —NH₂ groups) and acrylic acid/CO₂ (which leads to enhanced production of —COOH groups).

Further information on plasma processing may be found, for example, in “Functionalization of Polymer Surfaces,” Europlasma Technical Paper, May 08, 2004 and in U.S. Patent Application Publication No. 2003/0236323.

As another example, plasma-based techniques such as those described above may first be used to functionalize a substrate surface, followed by removal of a portion of the functional groups at the surface by exposing the surface to a laser beam, for example, in an inert atmosphere or vacuum in order to minimize deposition.

As another example, the substrate can be provided with a positive charge by covalently linking species with functional groups having positive charge (e.g., amine, imine or other basic groups) or functional groups having a negative charge (e.g., carboxylic, phosphonic, phosphoric, sulfuric, sulfonic, or other acid groups) using methods well known in the art. Further information on covalent coupling may be found, for example, in U.S. Pub. No. 2005/0002865.

As yet another example, charged groups may be introduced by non-covalently binding charged compounds to the polymers, for example, based on van der Waals interactions, hydrogen bonding, hydrophilic/hydrophobic interactions and/or other interactions between the substrate and the charged compounds.

For instance, a surface charge may be provided on a substrate by exposing the substrate to a charged amphiphilic substance. Amphiphilic substances include any substance having hydrophilic and hydrophobic groups. Where used, the amphiphilic substance should have at least one electrically charged group to provide the substrate surface with a net electrical charge. Therefore, the amphiphilic substances that are used herein can also be referred to as an ionic amphiphilic substances. Amphiphilic polyelectrolytes are used as ionic amphiphilic substances in some embodiments.

In some embodiments, a surface charge is provided on a substrate by adsorbing polycations (for example, selected from polyethylenimine (PEI), protamine sulfate, polyallylamine, polydiallyldimethylammonium species, chitosan, gelatin, spermidine, and albumin, among others) or by adsorbing polyanions (for example, selected from polyacrylic acid, sodium alginate, polystyrene sulfonate (PSS), eudragit, gelatin, hyaluronic acid, carrageenan, chondroitin sulfate, and carboxymethylcellulose, among others) to the surface of the substrate as a first charged layer. PEI is commonly used for this purpose, as it strongly promotes adhesion to a variety of substrates. Although full coverage may not be obtained for the first layer, once several layers have been deposited, a full coverage should ultimately be obtained, and the influence of the substrate is expected to be negligible. The feasibility of this process has been demonstrated on glass substrates using charged polymeric (polyelectrolyte) materials. See, e.g., “Multilayer on solid planar substrates,” Multi-layer thin films, sequential assembly of nanocomposite materials, Wiley-VCH ISBN 3-527-30440-1, Chapter 14; and “Surface-chemistry technology for microfluidics,” Hau, Winky L. W. et al. J. Micromech. Microeng. 13 (2003) 272-278.

Species which are covalently or non-covalently bound to the substrate may be applied by a variety of techniques. These techniques include, for example, deposition techniques, full immersion techniques such as dipping techniques, spraying techniques, roll and brush coating techniques, techniques involving coating via mechanical suspension such as air suspension, ink jet techniques, spin coating techniques, web coating techniques and combinations of these processes, among others. Micro-polymer stamping may also be employed, for example, as described in S. Kidambi et al., “Selective Depositions on Polyelectrolyte Multilayers: Self-Assembled Monolayers of m-dPEG Acid as Molecular Templates” J. Am. Chem. Soc. 126, 4697-4703, 2004. The choice of the technique will depend on the requirements at hand. For example, deposition or full immersion techniques may be employed where it is desired to apply the species to an entire substrate, including surfaces that are hidden from view (e.g., surfaces which cannot be reached by line-of-sight techniques, such as spray techniques). On the other hand, spraying, roll coating, brush coating, ink jet printing and micro-polymer stamping may be employed, for instance, where it is desired to apply the species only certain portions of the substrate (e.g., in the form of a pattern).

Once a sufficient surface charge is provided on a substrate, it can be readily coated with a layer of an oppositely charged material. Examples of such layers include layers that contain (a) polyelectrolytes, (b) charged particles or (c) both polyelectrolytes and charged particles.

Multilayer regions are formed by repeated exposure to alternating, oppositely charged materials, i.e., by alternating exposure to materials that provide positive and negative surface charges. The layers self-assemble by means of electrostatic layer-by-layer deposition, thus forming a multilayered region over the substrate.

A specific technique for assembling conductive layers of good conductivity is described in Yanjing Liu et al., “Layer-by-layer ionic self-assembly of Au colloids into multilayer thin-films with bulk metal conductivity,” Chemical Physics Letters 298 (1998) 315-319. In this process, conductive particles (e.g., metal particles such as Au nanoparticles) are encapsulated in polyelectrolyte (e.g., poly(diallyldimethylammonium chloride) (PDDA), thereby forming positively charged gold particles. A substrate (e.g., an Au-coated substrate) is exposed to a colloidal dispersion of the charged particles (e.g., PDDA-coated Au particles), rinsed, exposed to an oppositely charged polyelectrolyte (e.g., a solution of poly s-119 from Sigma), rinsed, exposed to a colloidal dispersion of charged particles, rinsed, exposed to oppositely charged polyelectrolyte, rinsed, and so forth, until the desired number of layers are deposited. Samples containing 15 and 20 Au-PDDA/poly s-119 bilayers, respectively, were found to have resistivities of 5.4×10⁻⁶ and 5.6×10⁻⁶ Ωcm, respectively, approaching the bulk resistivity of Au (2.4×10⁻⁶ Ωcm).

A specific example of a technique for assembling dielectric layers of good resistivity is discussed in A. A. Antipov et al., Advances in Colloid and Interface Science 111 (2004) 49-61 and references cited therein. In this technique, layer-by-layer-deposited poly(acrylic acid) (PAA)-poly(allylamine hydrochloride) (PAH) multilayer films are crosslinked via heat-induced amidation. 10-nm-thick films with a resistivity of about 5×10⁶ Ωcm² are reported. Crosslinking in this way also enhances film stability in aqueous solutions. Id.

Hydrophobic multilayers may also be employed as dielectric films, eliminating the need to use heat for crosslinking films, which is advantageous for drug delivery layers. In this regard, see, e.g., R. M. Jisr et al., “Hydrophobic and Ultrahydrophobic Multilayer Thin Films from Perfluorinated Polyelectrolytes,” Angew. Chem. Int. Ed. 2005, 44, 782-785. The polyelectrolytes employed include Nafion, 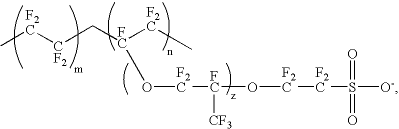
and a polycation synthesized from poly(vinylpyridine) and a fluorinated alkyl iodide,

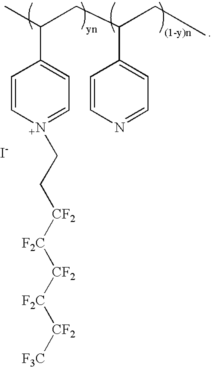

These and other techniques may be employed to construct resonators, rectifiers, and other electrical circuits on a wide variety of substrates.

### EXAMPLE 1

A structure like that of FIG. 5A may be designed along the following lines. A first conductive layer corresponding to a first conductive line 530a and lower capacitor plate 535a is constructed on a tubular substrate, for example, using micro-polymer stamping along the lines described in S. Kidambi et al. supra in combination with layer-by-layer deposition of PDDA-coated Au particles and poly s-119 as described in Yanjing Liu et al. supra. An insulating layer, for example, a crosslinked PAA/PAH multilayer film is then deposited over the conductive layer, except where interlayer electrical contact is desired (e.g., the end of the first conductive line). A second conductive layer corresponding to a second conductive line 530b and upper capacitor plate 535b and coil 530c is then deposited to complete the LC circuit.

### EXAMPLE 2

According to Faraday's law, the voltage generated in a coil is V=−NAdB/dt, where N=number of windings in the coil, A=the area of the coil, B=the magnetic field strength and t=time. The FDA recommends that the exposure to RF energy be limited, specifically, that dB/dt be less than 60 T/s. See http://www.cis.rit.edu/class/schp730/lect/lect-17.htm For a single loop coil with diameter 4 mm (e.g., a typical coronary stent diameter), one arrives at V=60 [T/s] 12×10⁻⁶ m²=7.2.10⁻⁴ Volt. A layer-by-layer region of 75 nm thickness has a measured resistivity ρ of 5.4×10⁻⁶ Ωcm=5.4×10⁻⁸ Ωm. See Yanjing Liu et al. supra. Using 200 bi-layers, a layer thickness of approximately 1 micron is produced (using more layers will reduce the resistance and thus increase the Q-factor of the resonator as discussed below). Assuming a trace thickness T of 1 micrometer and a trace width W of 1 mm, one may calculate a resistance R=ρL/A=ρπD/(WT)=5.4×10⁻⁸π4×10⁻³/1×10⁻⁹=0.68 Ω. The dissipated heat Q per second is therefore=V²/R=7.6×10⁻⁷ Joule/s. Taking this multilayer region's density as half that of gold=19.3 g/cm³, the mass m for one loop of the coil is (0.5)(19.3 g/cm³)(10⁻⁴ cm width)(0.4 πcm length)(0.1 cm width)=1.211×10⁻⁴ g. The specific heat coefficient of gold is C=0.126 J/gK, so in one second one gets a temperature rise of dT=Q/(Cm)=5.0×10⁻² Celsius/s. Consequently, even without the heat dissipated to the surrounding blood, such a coil would not overheat during NMR imaging.

Given that f=42.6 MHz/Tesla (the Larmour frequency for hydrogen), at T=1.5 T one needs a resonance at 63.9 MHz. For a coil, self-inductance is given by L=μN² A/l, where N is the number of coil windings, A is the area of the coil and l is the length of the coil. Assuming a stent of length of 18 mm with traces 1 mm in width and having a gap of 0.1 mm (16 windings) and given that μ≈4π×10⁻⁷ T m/A for blood, then L=227 nH. At resonance ω=2πf=1/(LC)^{1/2}. Thus, to obtain a resonance at 64 MHz, one needs to add a capacitance of 27 pF to the LC circuit. As noted above, Yi Liu et al. report that they expect the capacitance of a capacitor having a polyimide dielectric to be more than 300 pF when using metal electrodes. Hence, to get to a 27 pF capacitor, an area of only 0.4 mm² is needed.

Given that Q=2π fL/R, and with R=0.68 Ohm/winding×16 windings=10.9 Ohms, then Q=8.4. Q is independent of the number of windings, because both R and L proportional with respect to the number of windings. However, one may increase the Q factor by raising the trace thickness in order to reduce the resistance.

Q is also defined as the width of the resonance peak (Δf) at 50% of the resonance value divided into the resonance frequency, or Q=f/Δf. Thus, Δf=7.6 MHz.

If the stent expands from 4 mm to 5 mm (i.e., a 25% increase), the inductance also goes up by 25%. The resonance frequency shifts by the inverse square root of the inductance from 64 MHz to 57 MHz. This means that an expansion of the stent from 4 to 5 mm already shifts the resonance peak well beyond the 50% level at a Q of 8.4.

Consequently, much higher Q factors are not realistic to use and this is actually a practical quality factor to use. In this connection, when using gold as a coil material in certain resonators, one may encounter an excessively high Q factor. The Q factor may be reduced, however, by adding a resistor to the circuit. For example, a region of conductive polymer such as that described in Yi Liu et al. above may be deposited for this purpose.

### EXAMPLE 3

Electroactive polymers may be used for a number of purposes in medical devices, including electric-controlled actuation and drug delivery purposes. See, e.g., U.S. Pat. Pub. No. 2005/0165439 entitled “Electrically actuated medical devices,” U.S. Pat. Pub. No. 2005/0102017 entitled, “Electroactive polymer actuated sheath for implantable or insertable medical device,” U.S. Pat. Pub. No. 2005/0102017 entitled “Robotic Endoscope,” U.S. Pat. Pub. No. 2003/0212306 entitled “Electroactive polymer based artificial sphincters and artificial muscle patches” U.S. Pat. Pub. No. 2004/0143160 entitled “Universal, programmable guide catheter” and

U.S. Ser. No. 11/055,930 filed Feb. 11, 2005 and entitled “Internal medical devices for delivery of therapeutic agent in conjunction with a source of electrical power.”

Gold wires or sputtered gold layers may be employed as a means to get current from outside the body to the electroactive polymers within the devices, for example, by way of a suitable diameter shaft of a catheter device, as can multilayer regions such as those discussed above (see, e.g., Yanjing Liu et al. supra).

For example, assume that a polypyrrole (PPy) film actuator is provided at the distal end of a 1.5 meter long catheter with diameter of 2 mm. The charge required to oxidize or reduce a given PPy film is fixed. For a 500 nm-thick PPy (DBS) film, the positive charge consumed by PPy oxidation is about 6.9 mC/cm², the negative charge consumed by PPy and oxygen reduction is about 8.5 mC/cm², and the maximum current observed during application of a 0.25 Hz square wave between −0.1 and −1.0 V has been shown to be around 25 mA. See E. Smela et al., “Electrochemically Driven Polypyrrole Bilayers for Moving and Positioning Bulk Micromachined Silicon Plates,” Journal Of Microelectromechanical Systems, Vol. 8, No. 4, DECEMBER 1999, pp. 373-383. Electrical connection may be established with the actuator by covering half the circumference of the catheter with a conductive layer having a thickness of 150 bi-layers=750 nm as described in Yanjing Liu et al. supra. The resistance of this layer would be around 18 Ohm. Based on the above, an actuator of 5 micrometer thickness (more useful than the 500 nm film of Smela et al.) could readily be operated using an activation current of about 150 mA, for which one would observe a very reasonable voltage drop of 2.7 Volt.

Although various embodiments are specifically illustrated and described herein, it will be appreciated that modifications and variations of the present invention are covered by the above teachings and are within the purview of the appended claims without departing from the spirit and intended scope of the invention.

1. An implantable or insertable medical device comprising a substrate and an electrical circuit that comprises a multilayer region disposed over said substrate, said multilayer region comprising (a) a plurality of polyelectroyte layers which comprise a polyelectrolyte, (b) a plurality of particle layers which comprise charged particles, or (c) a plurality of polyelectroyte layers which comprise a polyelectrolyte and a plurality of particle layers which comprise charged particles.

2. The implantable or insertable medical device of claim 1, wherein said multilayer region is a conductive region.

3. The implantable or insertable medical device of claim 1, wherein said particles comprise a conductive material.

4. The implantable or insertable medical device of claim 1, wherein said particles comprise gold.

5. The implantable or insertable medical device of claim 1, wherein said particles comprise nanoparticles.

6. The implantable or insertable medical device of claim 1, wherein said multilayer region is an insulating region.

7. The implantable or insertable medical device of claim 1, wherein said circuit comprises an inductor.

8. The implantable or insertable medical device of claim 7, wherein said inductor comprises a conductive coil comprising a conductive multilayer region.

9. The implantable or insertable medical device of claim 8, wherein said coil is selected from a helical coil and a birdcage coil.

10. The implantable or insertable medical device of claim 1, wherein said electrical circuit comprises a capacitor.

11. The implantable or insertable medical device of claim 10, wherein an electrode of said capacitor comprises a conductive multilayer region.

12. The implantable or insertable medical device of claim 10, wherein said capacitor comprises an insulating multilayer region

13. The implantable or insertable medical device of claim 1, wherein said electrical circuit comprises an inductor and a capacitor.

14. The implantable or insertable medical device of claim 13, wherein said circuit is a resonant circuit that has a frequency range which encompasses an emitted radiofrequency of an external device.

15. The implantable or insertable medical device of claim 14, wherein said external device is an MRI machine.

16. The implantable or insertable medical device of claim 15, wherein said device is a stent.

17. The implantable or insertable medical device of claim 14, wherein said device is a balloon.

18. The implantable or insertable medical device of claim 17, wherein said resonant circuit has a resonant frequency that changes as said balloon is inflated.

19. The implantable or insertable medical device of claim 17, wherein said balloon contains a plurality of resonant circuits each having a resonant frequency that changes as said balloon is inflated.

20. The implantable or insertable medical device of claim 1, wherein said circuit comprises an antenna that comprises a conductive multilayer region.

21. The implantable or insertable medical device of claim 1, wherein said circuit is biostable.

22. The implantable or insertable medical device of claim 1, wherein said circuit is bioabsorbable.

23. The implantable or insertable medical device of claim 1, wherein said substrate is selected from a metallic substrate, a polymeric substrate and a ceramic substrate.

24. The implantable or insertable medical device of claim 1, wherein said substrate is biostable.

25. The implantable or insertable medical device of claim 1, wherein said substrate is bioabsorbable.

26. The implantable or insertable medical device of claim 1, wherein said medical devices are selected from stents, grafts, catheters, balloons, sensors, MEMS devices, sheaths, pumps and drug delivery tubes.

27. The implantable or insertable medical device of claim 1, wherein said electrical circuit comprises a diode.

28. The implantable or insertable medical device of claim 27, wherein said diode comprises a plurality of particle layers which comprise charged semiconductor particles.

29. The implantable or insertable medical device of claim 1, wherein said electrical circuit comprises a rectifier.
